(19) United States
(12) Patent Application Publication
(10) Pub. No.: US 2013/0075468 A1
(43) Pub. Date: Mar. 28, 2013

(54) SYSTEM AND METHOD FOR RECYCLING OF ARTICLES

(71) Applicants: EVER GREEN ENVIRONMENTAL CORPORATIO, St. John's (CA); HARRY CONNORS, St. John's (CA)

(72) Inventors: MICHAEL WADDEN, PARADISE (CA); JONATHON DROVER, ST. JOHN'S (CA); KURT W. WILLIAMS, ST. JOHN'S (CA)

(73) Assignee: EVER GREEN ENVIRONMENTAL CORPORATION, St. John's (CA)

(21) Appl. No.: 13/685,191

(22) Filed: Nov. 26, 2012

Related U.S. Application Data
(63) Continuation-in-part of application No. 12/898,175, filed on Oct. 5, 2010, now abandoned.

(51) Int. Cl. G06Q 50/10; G06Q 20/10

(52) U.S. Cl. CPC G06Q 50/10; G06Q 20/10
USPC 235/379

(57) ABSTRACT

The invention relates to a system for receiving recyclable items having a deposit value from a customer, comprising a user station comprising means to generate tags bearing a unique tag identifier, an sorting station comprising an sorting interface for entering the tag identifier and the numbers and types of recyclable items, and a computer in communication with the customer and sorting interfaces, to calculate the total deposit value for recyclable items and ascribe a deposit value to said customer account, and to update the customer account with a monetary amount correlating to said deposit value.

### CROSS-REFERENCE TO RELATED APPLICATION

This application is a Continuation in Part of application Ser. No. 12/898,175, filed on Oct. 5, 2010, which claims the benefit of U.S. application No. 61/248,669, filed on Oct. 5, 2009, the contents of both of which are incorporated herein by reference.

### FIELD OF THE INVENTION

The invention relates to systems and methods for handling of recyclable articles that bear a deposit value, such as recyclable bottles and cans. In particular, the invention relates to an integrated system for tracking recyclable articles received from a customer and generating a customer account wherein the deposit values of recyclable articles are ascribed to the customer.

### BACKGROUND

Within many jurisdictions, consumers are encouraged to recycle a variety of articles such as beverage bottles and the like by a deposit system wherein a deposit is charged at the point of purchase, which can be redeemed when the article is returned to a deposit location. Unfortunately, compliance with this type of system remains far from perfect; this may be due in part to the inconvenience suffered by the consumer when returning the articles. For many individuals, the inconvenience outweighs the value of the returned deposit. While increasing the amount of the deposit may increase compliance, this is often undesirable due to the hardships it imposes on the less wealthy. As well, the inconvenience factor is unaffected with such an approach. A preferable approach is to increase compliance by reducing the inconvenience factor; this is expected to result in more such articles being returned by consumers. This will achieve an overall economic benefit as it places more disposable income in the hands of consumers, and as well achieves significant environmental benefits in terms of recycling of items and reduced burden on landfills.

A significant inconvenience factor relates to the time required by consumers waiting at deposit centers while their articles are counted, sorted, etc. This can give rise to lineups during busy hours, and can result in overall frustration with the amount of time required for the relatively small deposit amount generally received by a customer. This has resulted in an increasing portion of recyclable containers being diverted to landfill, in particular as the value of deposits, which tend not to be increased over time, is slowly eroded by inflation. There is thus a need to provide a system for speeding up and generally facilitating the process of returning recyclable items and processing the deposit amounts.

One constraint on handling of returned articles resides in the physical limitations imposed at a typical recycling center. Typically, numerous consumers arrive at peak hours, and the recycling centers often have only a small area devoted to the consumer intake area or a small staff to process the returns, resulting in bottlenecks when processing the recyclable items. As well, certain users of the system, particularly those engaged in gathering recyclable items on a large scale, can bring in very large numbers of such items, thereby aggravating the bottlenecks. In order to address such problems, various automated systems have been proposed and developed, for example vending-type machines which accept recyclable items and return the deposit amount to the consumer. However, such machines are highly complicated and costly, and are generally only capable of recognizing a relatively small range of recyclable items, such as conventional beer bottles or soda cans. As a result, it can be difficult for such machines to adapt to the introduction of a deposit on a new type of article. As well, the high cost of such machines generally limits the numbers of machines and locations where these are available, resulting in the same bottleneck problem as noted above. It is thus desirable to provide a system which is relatively inexpensive and avoids at least some of the above drawbacks.

An improved system for processing of recyclable articles was disclosed in a previous application filed by the present applicant, namely U.S. application Ser. No. 12/080,632, filed on Apr. 4, 2008. The present invention relates to improvements of said system. A system for recycling articles has also been disclosed in U.S. patent publication no. 2007/0275586 A1, published Nov. 29, 2007.

### SUMMARY OF THE INVENTION

According to one aspect, the invention relates to a system for receiving unsorted recyclable articles having a deposit value from a customer, said customer having a customer information carrier bearing a unique customer identifier, or other means to confidentially access a controlled system. The articles may be placed within a container such as a bag or box, to which a unique container identifier can be attached. The container can be filled with articles either when operating the customer interface described below, or in advance. According to this aspect, the system comprises:

a depot for depositing of recyclable articles comprising a user interface for a computer, an automated reader to read a machine-readable information carrier uniquely associated with the customer and a label generator for generating and dispensing a machine-readable label bearing a unique identifier for attachment to the recyclable articles or a container thereof, such as sealable sack or box,

at least one sorting station which may be remote from the depot comprising a computer interface for electronically reading the label. The sorting station is configured to allow an operator to sort the articles into a plurality of receptacles. The station includes a user interface for the operator to enter data into a computer relating to the numbers of said articles identified by article type sorted into said receptacles, and,

a computer system at a data center in operative communication with the user interfaces of the depot and sorting station. This computer comprises a memory, a processor and program instructions to: generate an individual customer account for said customer in response to a demand by said customer, maintain a record of said labels upon generation thereof, tabulate and update (either in real time or on a periodic basis) system-wide and sorting inventory levels said articles present within said system in response to article data entered at said sorting stations, determine a financial value for articles associated with each of said labels and update said customer account with said financial value.

The data center computer can also generate system-wide financial values reflective of inventory levels of articles, responsive to said article data entered at said sorting stations. The financial information can also include funds in customer accounts.

The data center can further provide an information transmission to an article pick-up service provider to signal said provider to pick up said sorted articles from said sorting station. The information transmission can be triggered by one or both of a user-activated information transmission or an information transmission activated in response to a predetermined inventory level at said sorting station.

The system may further comprise an email generator responsive to customer sorting data generated at said sorting station, wherein an email is sent to said customer upon updating of said customer account to inform the customer of the value of funds added to the account by the customer-deposited articles, and optionally informing the customer of the numbers, types and/or individual deposit values of said articles.

The system can be adapted to update the customer account with information specific to each customer transaction selected from the date and time of issuing of a tag to the customer, the number of tags issued to the customer, the number and types of recyclable articles within each sack delivered by the customer, the deposit value associated with each of said articles, and similar information for any selected time period.

According to another general aspect, the invention relates to a method for processing recyclable articles, using the system described above to carry out the following steps:

establishing a customer account containing customer information

providing a customer with an information carrier bearing a unique customer identifier permitting access to said customer account, such as a card with a chip, bar code or magnetic strip; alternatively, system access may be provided by entry of a PIN or other confidential information by the customer;

permitting a customer transaction at an unmanned deposit station, consisting of reading the customer information carrier with a reader to obtain customer identification information, and communicating said information to an information processor;

receiving input from the customer as to the number of containers of recyclable articles that the customer intends to deposit at the station;

generating one or more tags corresponding to the number of such containers, wherein the tags each bear a unique container identifier, said unique identifier container information being stored within said processor linked to the corresponding customer account;

attaching said tag to a container which contains the customer's recyclable articles,

at a sorting station, entering into said processor for each of said containers: a) the numbers and types of recyclable articles within said container and b) the unique container identifier associated with said container;

calculating a deposit value for said containers and updating said customer account to update the monetary value within said account responsive to said calculated deposit value;

tabulating and updating inventory levels of said articles present within said system in response to article data entered at said sorting station; and,

providing a payment to said customer of all or part of the monetary value in said account, on demand by the customer or automatically upon the occurrence of a time or value-based trigger.

The invention further relates to an unmanned recycling depot, consisting of a consumer interface as described above, operatively linked to a remote data center for providing the functions as described above, and a location for depositing recyclable articles in particular when placed in sacks or other containers that have been labeled with a unique tag associated with a customer account and which contain recyclable articles, for subsequent sorting and processing of deposit information into a customer account.

The invention will be further described by a non-limiting detailed description of an embodiment.

### BRIEF DESCRIPTION OF THE DRAWINGS

FIG. 1 is a schematic drawing showing the present system.

FIG. 2 is a flow chart, illustrating the present system and method.

FIG. 3 is a schematic drawing of an unmanned recycling station according to the present invention.

FIGS. 4a, 4b and 4c are flow charts further illustration the present method and system.

FIG. 5 is a schematic drawing of an embodiment of the present invention.

### DETAILED DESCRIPTION

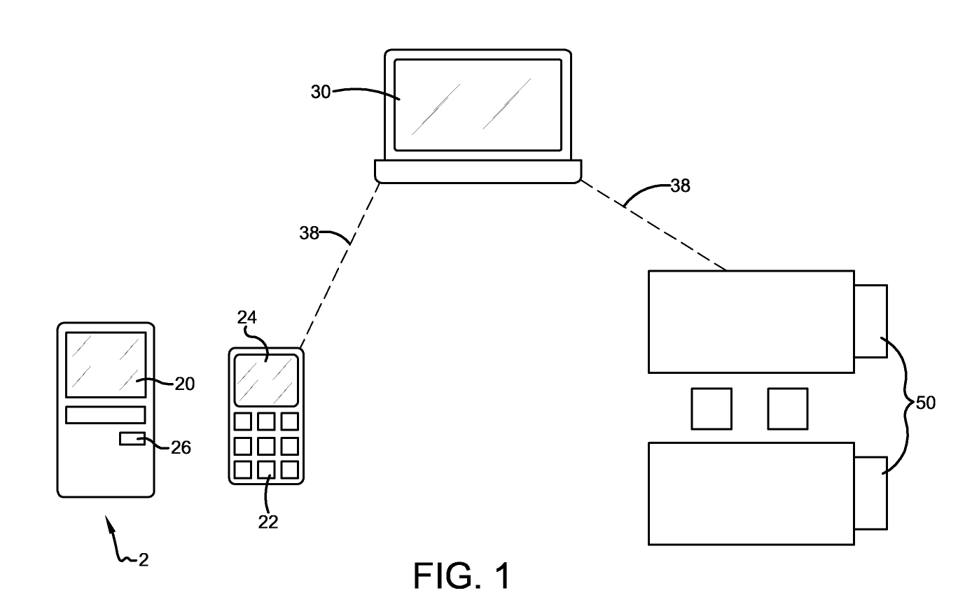

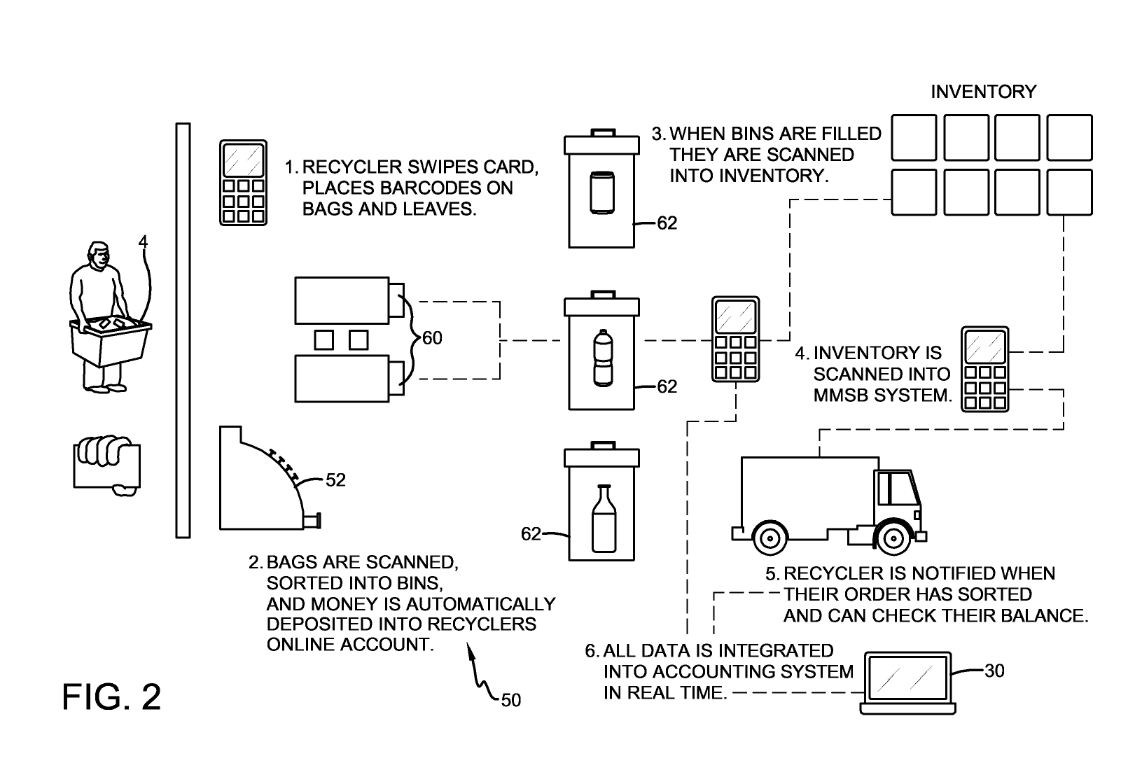

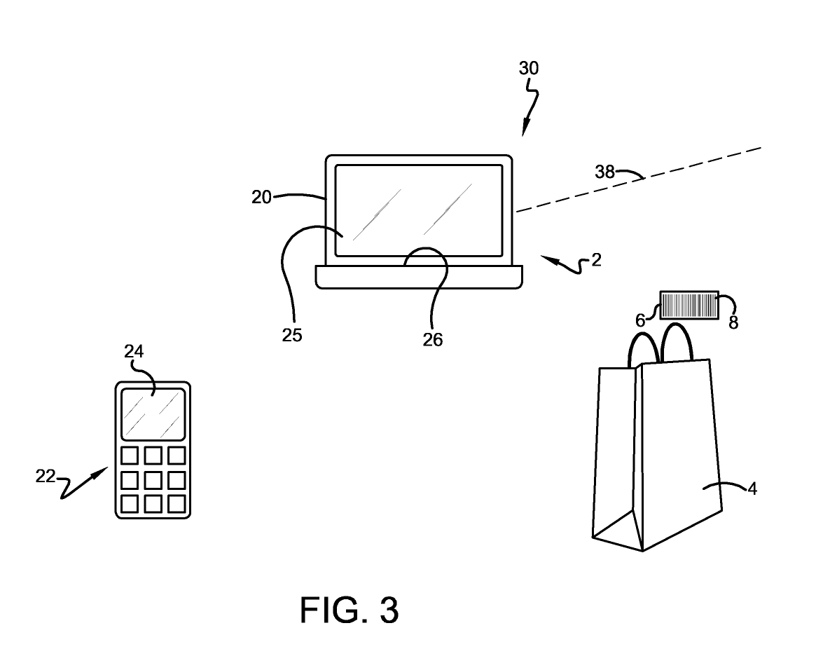

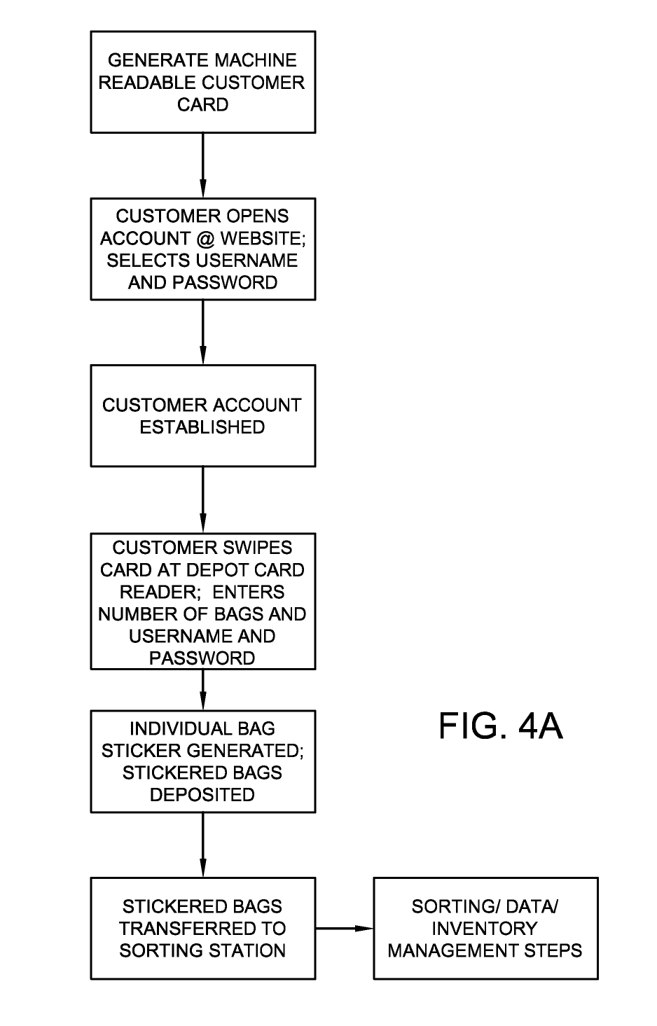

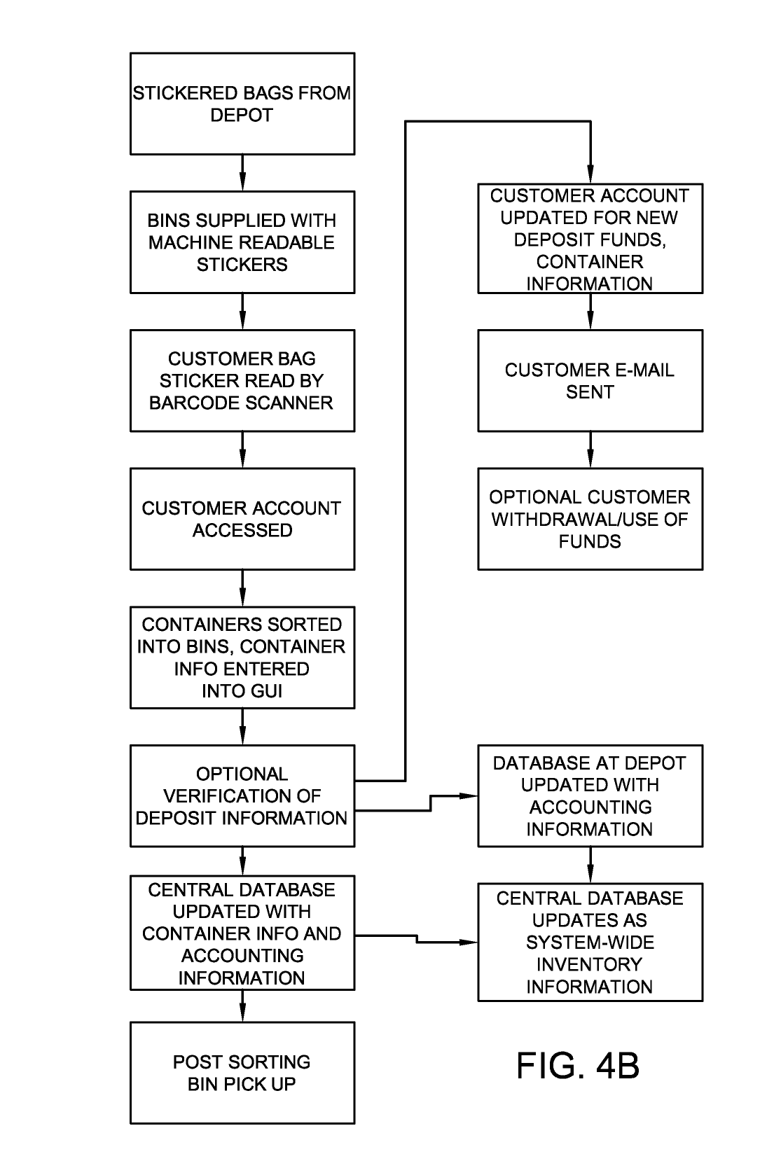

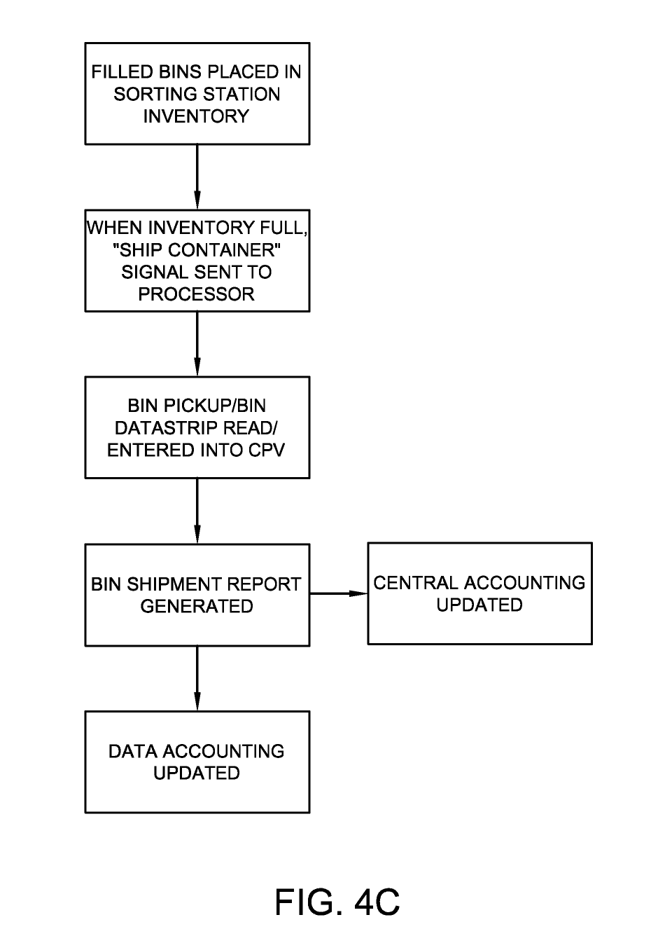

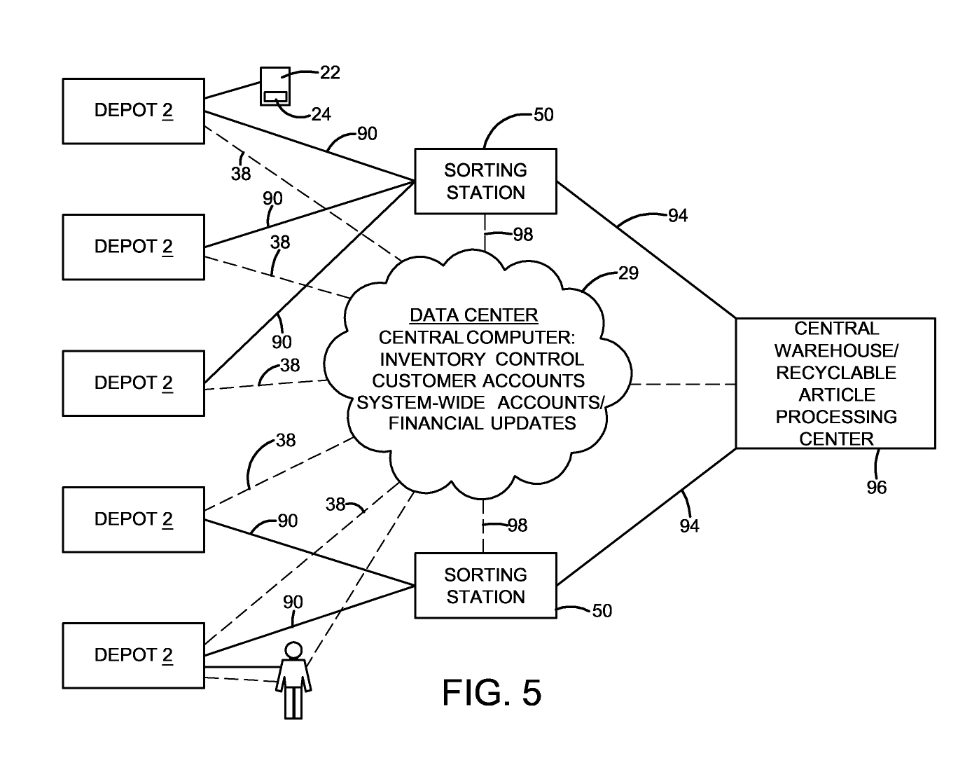

Turning to FIGS. 1-3, the present system includes an unmanned user depot or station 2, which can be located at any convenient location such as a shopping mall, beverage retailer or elsewhere. The depot is intended for use by a customer who wishes to deposit a number of recyclable articles such as deposit bottles or other items or containers for which a deposit has been paid. The customer may also wish to deposit other types of recyclable articles which do not bear a deposit; the present system is suitable for this purpose as well. Typically, the customer will have pre-packaged the items within a bag 4 or other container. The customers may have been previously supplied with standardized bags or containers, although this is not essential and customers may supply their own bags. Suitable bags or other containers may also be available at the user station for customers to fill on the spot with their articles. Bags 4 should be well sealed to prevent recyclable articles from falling out during handling. For this purpose, customers may be supplied with fasteners 6 which securely seal the bags. The fastener can form a tamper-proof seal to prevent unauthorized removal of containers from bag 4. The fastener may also include a machine-readable identifier tag 8, as will be described below, or the tag 8 may be separate from the fastener.

Customers at station 2 encounter a user interface unit 20 which may comprise a kiosk or similar interactive display unit. The interface may comprise a free-standing unit or a unit which is placed on a table, counter or other support. The interface unit is suitably robust to withstand the normal requirements of an unmanned station. Customers use a pre-issued card 22 or similar information carrier to initiate use of the system. The information carrier includes a unique customer identifier 24 such as a magnetic strip, chip, barcode, RFID or other machine-readable data carrier. Customer identifier 24 can be read by card reader 26 incorporated with interface unit 20 to permit access to a pre-established customer account. In most cases, customers entering the facility will have already registered with the system and will have been previously issued a customer identification card and an associated account. However, for a new customer, the customer will be required create an account. This may require the customer to input basic identification into the customer interface, for example full name, address, contact information and any other suitable information as may be required. This information is recorded in the central computer 30, as described below. The customer can be mailed the card at a later date, for future use. The user station may also be equipped to generate and dispense the card on the spot.

The user interface unit 20 includes a screen 25 or other similar display. Preferably, the screen is a touch screen or alternatively a separate screen and keyboard (not shown) is provided to permit customers to view and input information. Upon insertion or scanning of customer card 22, the user interface sequentially displays the following information, in a fashion wherein each sequential screen is displayed upon command by the user:

display of customer identification for optional verification by the customer;

on demand, a display of customer's current account information, which may comprise current account balance, number of items deposited for recycling within a previous specified period and other information;

a request to input the number of bags or containers containing recyclable items that the customer is depositing at the present visit;

optionally, the customer can be asked to verify the selected number of bags.

The user interface unit 20 will then generate the appropriate number of unique, machine-readable container or bag tags. These may consist of stick-on labels or any other convenient information carrier which may be fastened or attached to the customer's containers. It is desirable to provide a tag which is suitable for attachment to a wide range of container types and materials. Suitably, a stick-on paper or plastic label is appropriate for most uses. Alternatively, if customers are limited to the use of bags or sacks for returning items, in particular standardized bags supplied to the customers, then a secure bag closure may be provided which incorporates the tag. This arrangement is desirable in that it ensures that the customer can be provided with a secure bag closure to minimize the risk of inadvertent premature or unauthorized opening of the bag. The identifier tag bears a unique identifier, such as a uniquely generated barcode.

The identifier tags are printed using a bar-code printer within the kiosk.

The customer can then apply tags 8 to the bags he has brought to the recycling station. The labeled and sealed bags are then deposited at depot 2, for transfer to a sorting station 50.

User interface 20 includes an information processor, such as a pre-programmed chip or a general purpose computer, programmed to carry out the functions described above. User interface 20 is in operative communication via a data link 38 with a data center 29 that comprises a computer 30. Data center 29 may be associated with multiple recycling stations via multiple data links 38. Data link 38 comprises any suitable digital communication means capable of transmitting digital information from the kiosk to the central computer, such as a wireless communication link or an Internet-based connection. The functions of central computer 30 will be described more fully below.

Depot 2 further comprises a secure location to receive containers 4, in order to avoid theft of the containers left by the customer. The secure location can comprise, for example, a cabinet or other large container having a lockable door and a one-way hatch, which can be integrated with the user station or located adjacent thereto. Optionally, depot 2 may be manned and the containers 4 are provided to the attendant.

The system further comprises a sorting station 50 for carrying out the functions of counting and sorting the recyclable articles and entering the corresponding deposit information in the associated customer accounts. Sorting station 50 can be located at a position which is remote from depot 2 or at the same general location. A remote location for sorting station 50 is particularly suitable where space is at a premium, for example at a shopping mall. It can also be desirable to provide a number of relatively small scale depots with a more limited number of sorting stations located remotely from at least some of the user stations. Labeled article containers 4 are conveyed at 90 from depots 2 to a corresponding sorting station 50.

Sorting station 50 comprises a facility for opening the customer bags or other containers 4 and counting and sorting the individual recyclable containers into large bins, sacks or other containers 62. Each customer container 4 is sorted individually and the articles therein are entered into the database associated with the individual customer, as described below. Containers 62 are each provided with a tag 92 that has a bar code or other machine-readable unique identifier for tracking purposes. Empty containers 62 are provided and their bar codes scanned by a portable scanner which can upload data to central computer 30 and/or a computer located at sorting station 50. The container identification information is transmitted to central computer 30. Articles may be sorted into containers 62 according to various criteria such as container type such as beer bottles, wine bottles, etc., glass color or any other selected criteria. The sorting process is generally conventional and may be carried out by hand or by machine. Sorting station 50 includes a computer 51 with a user interface 52, configured for convenient use by the sorters, to permit the sorting to enter information into computer 30 as the articles are sorted into containers 62. Alternatively, if the sorting occurs by machine, the interface is incorporated is incorporated within the sorting machine so as to automatically input the required information. As articles are sorted into containers 60, central computer 30 maintains an updated database of the numbers of articles within each container 62 at the sorting station.

User interface 52 comprises any convenient means to input data into computer 30 and to receive data from computer 30 as required to permit the sorting to update the customer account with the information derived from sorting the customer's bags. Without limitation, the data input means may comprise a graphic user interface (GUI) such as a touchscreen, a handheld device, a keyboard and screen combination, a voice-activated system, or various combinations of the foregoing. The GUI depicts graphically the various article types that are commonly processed, such as beer bottles, beer and soda cans, wine bottles (where these bear a deposit) and other deposit and non-deposit bearing articles. The GUI screen permits the operator to identify by touch the article type and the number of such articles being deposited within each sorting bin or container.

Sorting station 50 comprises a suitable and convenient arrangement and configuration of tables 60, bins/containers 62 and other equipment to permit the rapid and safe sorting of the containers, commencing with the opening of the customer containers and proceeding with the removal of the recyclable containers, entering the container types via interface 52 and depositing the sorted containers into receptacles. Optionally, the bin labels comprise removable tags 92 that have a machine-readable identifier thereon. The machine-readable readable label 92 can be affixed to the bin by the operator either before, during or after the article sorting step. Alternatively, the bins may be supplied with machine-readable labels pre-attached, and the operator scans or otherwise reads the label in the sorting process to enter the bin identification information into the data center computer. The removable label 92 can be removed from container 62 before its re-use by the operator, and a new label 92 attached. In this fashion, error is reduced with respect to tracking of containers 62 in the full or empty state.

Prior to sorting the articles from a customer's container 4, the operator will input the associated tag 8 into the interface, for example by scanning the barcode printed on the tag. In this fashion, individual container and customer information is entered into the information processor. As the recyclable articles are sorted, the operator also enters data into the customer account to update the customer account to reflect the numbers of articles supplied by the customer. For example, the sorting interface may graphically display the article types and/or the deposit amounts, if any, and the sorting can then enter the data corresponding to these articles into the customer account individually as articles are removed from the container, or after counting the sorting may enter total number of each type of article. If the customer has inputted the number of recyclable articles when the container were deposited at the depot, this information can be compared with the corresponding data generated at the sorting station and the customer account updated if required. The data entered by the operator is transmitted to the central computer, either in real time or after the operator has concluded the sorting process, and optionally a verification of the numbers. The central computer then converts the data relating to the numbers and types of articles into a dollar value that can be entered into the customer account, and the customer account is then credited with this amount.

The sorted articles are then placed within bins 62 or other receptacles for subsequent removal. The recyclable articles may comprise essentially any number and types of articles, not all of which may bear a deposit. In the case of articles that do not bear a deposit, the sorter may optionally sort such articles in a fashion similar to the sorting of deposit articles, or alternatively the non-deposit articles may be placed in a single bin or container for subsequent sorting and processing. The sorter may then enter the number and types of non-deposit articles received, or alternatively this latter information need not be entered since it will not affect the customer's account information. In this fashion, the system may be used in communities that do not provide a curbside recycling program, so as to permit consumers to recycle their recyclable articles at the same time as returning deposit-bearing articles. Optionally, information relating to both the deposit and non-deposit bearing articles may be input into the customer account, which permits the system to calculate the “carbon footprint” and other environment information relating to the customer's deposit. Such information includes the number and types of containers deposited by the customer. The computer 30 can be programmed with information relevant to the environmental factors respecting a number of types of recyclable articles, which can then be used to ascribe selected environmental information to the customer account.

Filled containers 62 are transported at 94 to a central warehouse 96, which may comprise a recyclable article processing center that processes recyclables for a region, or alternatively warehouse 96 may comprise one or more processors of select article types. For example, there may exist multiple warehouses 96 that consist of beer bottle/can recycle centers, soda bottle/can recycle centers and a non-deposit recycle center.

Upon completion of the sorting operation, including the associated data entry, an automatic notification is sent to the user to indicate that the containers have all been sorted, and that the customer's account balance has been updated and is ready for viewing.

Sorting station computer 51 is operatively linked to computer 30 at the data center by data link 98. As container information is entered into the GUI during the sorting process, this information is transmitted to computer 30, which updates inventory level information in real time on both a system-wide basis and within individual sorting stations.

When bins 62 are fully filled at the sorting station, the operator scans the bin information contained on the machine-readable bin label at the user station interface to input the bin information into the computer 30. Each bin is coded to indicate the type of container or article intended to be kept within the bin. The computer tracks the inventory of filled bins at the sorting station. When the inventory reaches a predetermined level, an order for a bin pickup is triggered. Bin pickup can also be initiated by sorting station by the sorting station transmitting a bin pickup request to the central station.

The sorting station 50 may comprise a single sorting location and single sorting interface 52. More typically, the sorting station will accommodate a number of sorters, each with a user interface 50 linked to computer 51 in communication with computer 30.

Computer 30 at the data center may comprise a general purpose computer, comprising program information to configure the computer to carry out the functions required to operate the present system. Preferably, the computer is also connected to the internet via secure internet connection for access to customer accounts by customers, operators and others.

Computer 30 is programmed to carry out the following operations and functions:

A. Maintain a database of customer accounts, including for each customer, the personal information for said customer, including a customer number assigned to the customer and optionally banking or other financial information for the customer such as a credit card or Paypal™ account to permit funds to be transferred, as well as an account for said customer including the deposit funds attributed to said customer, and a record of transactions of said customer with the system.

B. Generation of new customer accounts, including assignment of a customer number, or optionally the customer number may be supplied to the system from an external source such as a number being selected by the customer. Optionally, each customer may be identified by a customer number and/or user name as well as a confidential password. The customer account is initially randomly generated by the system until the user activates his account and configures his account details.

C. Receiving customer information from the customer interface, including accessing the customer account when triggered to do so by the reading of the customer identifier at the interface, and receiving from said interface the number of bag identifier tags required the customer, and any other information entered by the consumer in response to prompts generated by the system.

D. Signaling to said user interface to generate a corresponding number of tags, each of said tags comprising a unique identification number or other encoded information, and maintaining a record for said customer of said tags including the tag identifier information, and optionally generating a statement for said customer indicating information such as the date and time of said transaction, the number of tags issued to the customer and optionally other account information relevant to the customer.

E. Receiving from the sorting interface information corresponding to an individual tag identifier, and opening and accessing the customer account corresponding to said identifier. Upon opening of a customer account at the sorting end by scanning or otherwise reading the bag tag into the sorting interface, the operator is provided only limited information respecting the customer account. For privacy considerations, this information may be limited to simple confirmation that the tag identifier entered by the user corresponds to a valid customer account.

F. In response to information entered by the operator respecting the numbers and types of recyclable articles contained within a customer bag, entering into said customer account the numbers and types of deposit-bearing containers entered by the operator, and updating the customer account in respect of the value of said deposits.

G. Permitting customers to access their accounts, either via a secure digital connection or at a customer interface, and displaying selected customer account information, including the deposit value belonging to said customer held within said account.

H. Generating system-wide inventory information for each container type. Inventory information generated and tabulated by the computer includes inventory levels for each article type that is present in each of the sorting stations and which has been sorted into bins/receptacles, articles by type that have been transferred to a central warehouse or recycling center, and articles by type that are in transit to the warehouse. Inventory information can be consolidated into system-wide inventory information for each article type, as well as inventory within each of the predetermined locations of the articles within the system. Inventory information is conveyed to a recipient, such as a beverage container source or other entity responsible for paying out deposits. Inventory information may be transmitted to a qualifying recipient either on demand by the recipient or on a period (such as hourly, daily or weekly) or real time (ongoing) basis. Historic inventory information is also maintained.

I. Electronically transmitting and receiving funds between entities, corresponding to the calculated deposit amount. Relevant entities for funds transfer include the system account and a customer account, the system account and an outside customer/processor of bulk recyclable articles or other supplier or client. [Optionally, a secure data link may be established with one or more purchasers of deposit or non-deposit bearing articles, to provide real time or up to date information respecting the numbers, locations and expected delivery times of such articles. Optionally, the purchasers can transmit funds electronically to the system operator via the data link at any selected stage, such as upon initiation of a pick-up signal whereby articles are transported to the purchaser, or upon any other agreed-upon triggering event.]

J. Initiating bin/receptacle pick-ups from the sorting stations, either in response to a request from the sorting station operator or the central warehouse, or automatically upon inventory levels reaching a predetermined level for one or more article types within each sorting station. Bin/receptacle pick-ups may be rationalized across the system by input and real time integrating of road and traffic information to minimize the mileage and time spent on deliveries and pickups.

K. Ascribing at least a portion of said deposit amounts into individual customer accounts, corresponding to the deposit values for the containers returned by said customer. Optionally a portion of the deposit amounts paid to the system can be retained by the system sorting, as compensation for providing and operating the system. Optionally, the customer can be automatically sent an email or other communication indicating the updated account information to reflect the newly deposited articles, including the numbers and types of articles ascribed to the customer and the deposit value added to the customer account.

L. Upon request by a customer, transferring the deposit amounts to a third party, such as a bank account, credit card, PayPal™ account, or other means to transfer the funds from the system account to an account of an individual customer. Optionally, the funds may be supplied to a customer in the form of a cheque issued by the system and delivered to the customer.

Accounting information can also be updated, either periodically or on a real time basis. For this purpose, computer 30 tabulates the container numbers, deposit values and container types as these are deposited in the sorting bins at the sorting station as well as when the bins are shipped from the sorting station to either a central location or multiple container receiving locations. As these transactions occur, computer 30 can update the funds payable for the containers received, funds received from third party sources for recyclable containers, funds paid to customers, and optionally funds attributable to each sorting and customer stations.

All communication with the customer is engaged by the use of a bar coded card so as reduce the possibility of errors in identity. In the instance that a card is misplaced or not functioning, all customer information is available through a secure administration portal. This portal can be used to generate a new card or remedy human errors that may occur.

Optionally, the system may accumulate information and data on a periodic, real time or on-demand basis relating to system-wide basis relating to the total amounts of materials processed. Such information and data may include the total numbers of articles that have been processed by the system, organized by criteria such as types of articles, geographic locations of the customers, and the like. Such information and data may be used to generate periodic reports. One use of such reports is for submission to a greenhouse gas credit organization to obtain greenhouse gas credits or other benefits from the recycling activities.

Optionally, the computer may be programmed to provide an “environmental calculator” for each customer, accessible via the individual customer account. The environmental calculator provides information relating to the environmental benefits of the customer's activities and optionally other customers as well, including such aspects as the amounts of carbon and other resources saved by the customer's recycling activities.

In addition, advertising messages may be displayed at various opportunities, such as at the customer interface, either before or after the customer information is input, or on the user-accessible website, either before or after the customer account is accessed.

A further option for the customer account is to provide the customer with the option to donate all or a portion of the funds held in the customer account to a charitable organization. For this purpose, the system conveys the funds, along with the customer information, to the requested charity. The charity may then issue a receipt directly to the customer, or the receipt may be generated by the system and forwarded to the customer.

The present invention has been described in the foregoing by reference to a detailed description of particular embodiments and aspects of the invention. The present invention is not limited to said embodiments and aspects, but embodies departures from and equivalents thereof. The present invention is defined by the present patent specification as a whole, including the claims, as well as embodiments which are within the spirit and scope of said claims and specification, and functional equivalents thereof as would be understood by persons skilled in the art to which this invention pertains.

Having thus described the invention, it is now claimed:

1. A system for processing recyclable articles having a deposit value, wherein said articles comprise a plurality of article types, said system comprising:
a depot for depositing of recyclable articles, comprising a user interface for a computer, a reader to read a machine-readable information carrier associated with said customer and a label generator for generating and dispensing a machine-readable label bearing a unique identifier for attachment to said recyclable articles or a container thereof,
at least one sorting station which optionally is remote from said depot comprising a computer interface for electronically reading said label, configured to sort the articles into a plurality of receptacles and a user interface for entering data into a computer relating to the numbers of said articles identified by article type sorted into said receptacles, and
a computer system in operative communication with the user interfaces of said depot and sorting station, said computer having a memory, a processor and program instructions to: generate an individual customer account for said customer in response to a demand by said customer, maintain a record of said labels upon generation thereof, tabulate and update system-wide and sorting inventory levels said articles present within said system in response to article data entered at said sorting stations, determine a financial value for articles associated with each of said labels and update said customer account with said financial value.

2. The system of claim 1 wherein said computer system further comprises program instructions to generate system-wide financial values for said inventory responsive to said article data entered at said sorting stations and said customer accounts, wherein said financial values comprise at least a monetary value of said inventory and a monetary value of funds in said customer accounts.

3. The system of claim 1 wherein said computer system program instructions are configured to tabulate and update said system-wide inventory level in real time.

4. The system of claim 3 wherein said customer accounts are updated in real time with the financial value of said articles upon sorting thereof.

5. The system of claim 1 wherein said computer system further comprises an information transmission to an article pick-up service provider to signal said provider to pick up said sorted articles from said sorting station, said information transmission being actuated by one or both of a user-activated information transmission or an information transmission activated in response to a predetermined inventory level at said sorting station.

6. The system of claim 1 wherein said computer system further comprises an email generator responsive to customer sorting data generated at said sorting station, wherein an email is sent to said customer upon updating of said customer account to inform the customer of the value of funds added to the account by the customer-deposited articles, and optionally informing the customer of the numbers, types and/or individual deposit values of said articles.

7. The system of claim 1 wherein said information carrier comprises an optically-scannable bar code, a magnetic strip, an RFID device or a readable computer chip.

8. The system of claim 1 wherein said depot is unmanned and remote from said sorting station.

9. The system of claim 1 wherein said computer is adapted to transfer a selected amount of the funds in said customer account to said customer or other selected recipient.

10. The system of claim 1 wherein said computer is adapted to update said customer account with information specific to each customer transaction selected from the date and time of issuing of a tag to said customer, the number of tags issued to said customer, the number and types of recyclable articles within each said container, the deposit value associated with each of said articles, and similar information for any selected time period.

11. The system of claim 1 wherein at least one of said user interfaces comprises a touch screen, a handheld device, a combination of screen and keyboard, a voice-activated system, or a combination thereof.

12. A method for processing recyclable articles having a deposit value, within a recycling system, comprising the steps of
establishing a customer account containing customer information
providing a customer with an information carrier bearing a unique customer identifier which permits access to said customer account;
at depot, reading said customer identifier with a reader to obtain customer identification information and communicating said information to processor computer;
generating at least one label comprising a unique container identifier for attachment to said articles or a container thereof and communicating said identifier to said computer;
at a sorting station, reading the label with a reader in communication with said computer;
responsive to reading of said label, accessing and opening at least a portion of said customer account at said sorting station;
sorting said articles into receptacles by article type and communicating the numbers of articles by article type to the computer;
calculating a deposit value of said articles associated with each of said labels;
updating said customer account to update the monetary value within said account responsive to said calculated deposit value;
tabulating and updating inventory levels of said articles present within said system in response to article data entered at said sorting station; and
providing a payment to said customer of all or part of the monetary value in said account.

13. The method of claim 12 further comprising the step of determining system-wide financial values for said inventory responsive to said article data entered at said sorting stations and said customer accounts, wherein said financial values comprise at least a monetary value of said inventory and a monetary value of funds in said customer accounts.

14. The method of claim 12 comprising tabulating and update said system-wide inventory level in real time.

15. The method of claim 12 wherein said customer accounts are updated in real time with the financial value of said articles upon sorting thereof.

16. The method of claim 12 further comprising an information transmission to an article pick-up service provider to signal said provider to pick up said sorted articles from said sorting station, said information transmission being actuated by one or both of a user-activated information transmission or an information transmission activated in response to a predetermined inventory level at said sorting station.

17. The method of claim 12 further comprising generating and transmitting an email responsive to customer sorting data generated at said sorting station, wherein an email is sent to said customer upon updating of said customer account to inform the customer of the value of funds added to the account by the customer-deposited articles, and optionally informing the customer of the numbers, types and/or individual deposit values of said articles.

18. The method of claim 12 wherein said depot is unmanned and remote from said sorting station.

19. The method of claim 12 further comprising transferring a selected amount of the funds in said customer account to said customer or other selected recipient.

20. The method of claim 12 further comprising updating said customer account with information specific to each customer transaction selected from the date and time of issuing of a tag to said customer, the number of tags issued to said customer, the number and types of recyclable articles within each said container, the deposit value associated with each of said articles, and similar information for any selected time period.
